(19) United States
(12) Patent Application Publication
(10) Pub. No.: US 2025/0134114 A1
(43) Pub. Date: May 1, 2025

(54) APPARATUS FOR FILLING FOOD ITEM AND METHOD OF USE

(71) Applicant: Eric TEASDALE, Leesburg, VA (US)

(72) Inventor: Eric TEASDALE, Leesburg, VA (US)

(21) Appl. No.: 18/883,334

(22) Filed: Sep. 12, 2024

Related U.S. Application Data
(60) Provisional application No. 63/592,995, filed on Oct. 25, 2023.

(51) Int. Cl. A21C 9/06

(52) U.S. Cl. CPC A21C 9/063

(57) ABSTRACT

An apparatus for filling a food item and method of use of the apparatus. The apparatus includes a filling receptacle enclosed by two pairs of opposed walls and having an open first end and an open second end, two pairs of opposed flaps disposed proximate the second end of the filling receptacle, each flap extending outwardly from each corresponding wall and oriented orthogonally thereto. When the apparatus is placed on a horizontal surface, the walls are disposed in a vertical orientation and the flaps extend horizontally outward from the filling receptacle, and the first end of the filling receptacle is above the second end. The apparatus is positioned over a flat, foldable food item to be filled, and ingredients are placed into the filling receptacle. The apparatus is then removed and the food item is folded to enclose the ingredients.

### CROSS-REFERENCE TO RELATED APPLICATION

This application claims the benefit of priority of U.S. Provisional Patent Application No. 63/592,995, filed on Oct. 25, 2023 and entitled “Apparatus for Filling Food Item and Method of Use,” the contents of which are incorporated herein by reference in their entirety.

### BACKGROUND

Many food items follow the basic formula of a base item, such as bread, tortillas, crepes, and others being filled with layers of food. For example, a classic food item is the burrito, which can include any number of fillings wrapped in a tortilla. However, when these food items are made improperly a number of issues can occur. For example, filling may be bunched up so that each bite is overwhelmed by a single ingredient. Additionally, when making an item like a burrito, it's easy for a home-cook to break the tortilla or wrapping and/or improperly wrap the burrito so that the fillings spill out as it is eaten.

### SUMMARY

In one or more embodiments an apparatus for filling food items and a method of use may be provided. The apparatus may include a filling receptacle, for example in the shape of a square or rectangle. The apparatus may further include one or more flaps that extend from the bottom edge of, and orthogonally to, the filling receptacle. The apparatus may further have an opening that extends through the filling receptacle to allow for the placement of food in the filling receptacle.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a perspective view of an exemplary embodiment of an apparatus for filling a food item;

FIG. 2 is a corner part, four of which are used to assemble the apparatus of FIG. 1, according to at least one embodiment;

FIG. 3 is another perspective view of the corner part of FIG. 2, with the unfolded position of an overlap flap thereof shown in dashed line to illustrate its initial fabrication position.

FIG. 4 is a perspective view of a portion of the corner part of FIG. 2, showing locking features within an interior slot formed in part by the overlap flap, according to at least one embodiment.

FIG. 5 is a perspective view of a tamping device for use with the apparatus of FIG. 1, according to at least one embodiment.

FIG. 6 is a flow chart representing a method for filling a food item utilizing the apparatus for filling a food item and tamping device.

FIG. 7A shows another exemplary embodiment of an apparatus for filling a food item.

FIG. 7B shows the apparatus of FIG. 7A in an alternate configuration.

FIG. 8 shows another exemplary embodiment of a tamping device.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

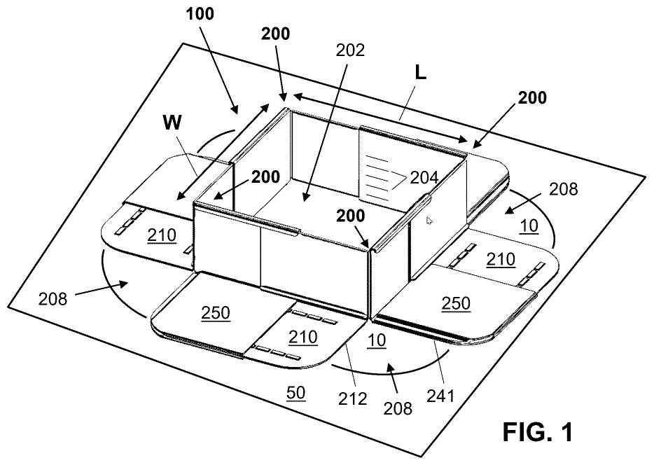

According to at least one embodiment, an apparatus 100 for filling a food item is described herein and illustrated in FIG. 1. The apparatus may be useful for assisting a food preparer in trimming, filling and folding a food item such as a tortilla, crepe, or wrap. The illustrated embodiment of the apparatus may be assembled from four elements, each referenced and described as a corner part 200. An exemplary food item 10 is represented in FIG. 1 as circular, and placed on a working surface 50.

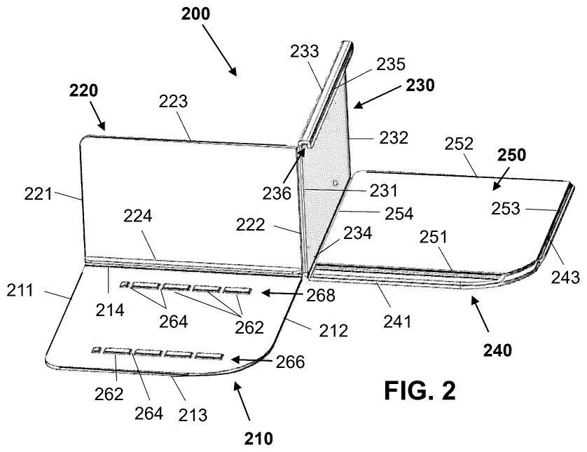

FIG. 2 shows a single corner part 200 isolated from the others and in a folded configuration as in the assembled apparatus 100. The part 200 in the illustrated embodiment is a one-piece unitary item having multiple planar members cooperatively forming a corner structure of the assembled apparatus 100. The illustrated embodiment of the corner part includes five planar members, described in the following as a first and second base flap, a first and second wall panel, and an overlapping flap folded over the second base flap. Each of the five planar members is generally rectangular, having beveled corners for safety and convenient use, and having parallel edges described in the following as opposite.

The first base flap 210 has a leading edge 211, an opposite trailing edge 212, an outer edge 213, and an opposite inner edge 214. The disposition of the first base flap 210 in the assembled apparatus is along or upon the food item 10 or a working surface 50, such a table, cutting block, or other host surface, which is expected but not required to be horizontal. For convenience, the in-use dispositions of features are described herein as horizontal and vertical in relation to the assembled apparatus 100 in use. According to this convention, the four edges of the first base flap are horizontal.

A first wall panel 220 has a vertical leading edge 221, an opposite vertical joined edge 222, a horizontal top edge 223, and an opposite horizontal lower edge 224. The in-use disposition of the first wall panel 220 is vertical, standing upright from the working surface 50 perpendicular to the first base flap 210. The lower edge 224 of the first wall 220 panel is connected to the inner edge 214 of the first base flap 210, for example contiguously connected by a living hinge.

A second wall panel 230 has a vertical joined first edge 231, an opposite vertical second edge 232, a horizontal top edge 233, and an opposite horizontal lower edge 234. The in-use disposition of the second wall panel 230 is vertical, standing upright from the working surface. The vertical joined first edge 231 of the second wall panel 230 is connected to the vertical joined edge 222 of the first wall panel 220, for example contiguously connected by a living hinge.

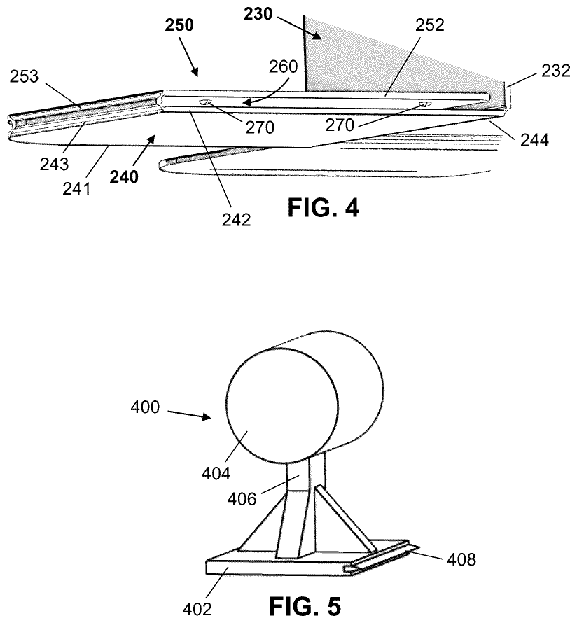

A second base flap 240 has a horizontal first edge 241 (FIG. 2), an opposite horizontal second edge 242 (FIG. 4), a horizontal outer edge 243, and an opposite horizontal inner edge 244. The inner edge 244 of the second base flap 240 is connected to the lower edge 234 of the second wall panel 230, for example contiguously connected by a living hinge. The in-use disposition of the second base flap 240 is horizontal, for example upon a working surface or food item

An overlap panel 250 (FIG. 2) has a horizontal first edge 251, an opposite horizontal second edge 252, a horizontal outer edge 253, and an opposite horizontal inner edge 254. The in-use disposition of the overlap panel 250 is horizontal, above and generally overlapping the second base flap 240. The outer edge 253 of the overlap panel 250 is connected (FIG. 4) to the outer edge 243 of the second base flap 240, for example contiguously connected by a living hinge. The first edge 251 (FIG. 2) of the overlap panel 250, is connected to the top surface of the second base flap 240 or the first edge 241 thereof, for example by a sonic weld, heat, or other fixing method making the position of the overlap panel 250 over the second base flap 240 permanent. The first edge 251 and outer edge 253 extend along different axes, which are mutually perpendicular in the illustrated embodiment. By joining the first edge 251 and outer edge 253 to respective corresponding portions of the second base flap 240, the overlap panel 250 is maintained as overlapping the second base flap 240.

A capture slot 260 (FIG. 4) is defined between the overlap panel 250 and second base flap 240 for receiving the leading edge 211 of the first base flap 210 of another same or similarly made corner part 200, four of which, when assembled together each at a respective corner, make the apparatus 100 of FIG. 1.

Cooperative locking features within the slot 260 and upon the first base flap 210 mutually engage to releasably and adjustably couple two corner parts 200. In the illustrated embodiments, the first base flap 210 (FIG. 2) includes, as locking features along its top surface, raised protrusions 262 spaced along lines parallel to the outer edge 213. Receiving notches 264 are defined between adjacent protrusions 262. Two lines of protrusions 266, referenced in FIG. 2 as a first line 266 and a second line 268, are shown in the illustrated embodiment.

Furthermore, in the illustrated embodiment, the overlap panel 250 (FIG. 4) includes locking features along its inner surface facing the upper facing surface of the second base flap 240 where the receiving slot 260 is defined. The locking features are illustrated as beveled tabs 270, each for engaging a respective line of protrusions 262 and notches 264. Upon the leading edge 211 of the first base flap 210 of one corner part 200 being inserted into the slot 260 of another corner part 200, the tabs 270 align with and click along the protrusions 262 to any notch 264 preferred by a user to set a side dimension of the apparatus. The overlap panel 250 flexes to permit the adjustment as the tabs 270 are moved along respective lines of the protrusions 262 to reach respective notches 264.

To improve engagement of any two coupled corner parts 200, a downturned lip 235 (FIG. 2) along the top edge 233 of each second wall panel defines a capture channel 236 for receiving the top edge 223 of the first wall panel 220 of a same or similar other corner part 200. The top edge 223 of one of two coupled corner parts slides adjustably within the capture channel 236 of the other of two coupled corner parts, mutually supporting the walls thereof and stabilizing the assembled apparatus 100.

The rectangular dimensions of the assembled apparatus nominally referenced as length L and width W in FIG. 1 are independently adjustable by adjustment of the coupled parts having walls extending along the respective dimension.

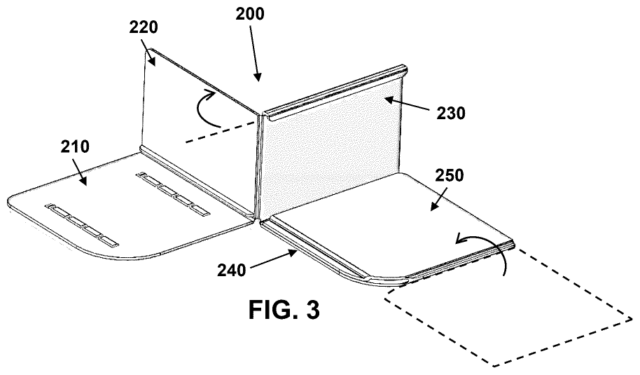

Each corner part 200, in at least one embodiment, is fabricated in an essentially flat condition and is folded to the folded configuration of FIG. 2. As shown in FIG. 3, for example, the overlap panel 250 is raised from the flat position marked in dashed line to its position overlapping the second base flap 240, and the second wall panel 220 is folded relative to the first wall panel 230 along their vertical joined edges. The first and second base flaps 210 and 240 are folded relative to their respective first and second wall panels 220 and 230.

The corner parts may be made, for example, by molding thermoplastic, 3D printing, or other fabrication methods. The material of the corner parts may be or include, as non-limiting examples, plastic, silicone, nylon, polypropylene, stainless steel, wood, and/or other materials. While the illustrated embodiment is described as fabricated as a one-piece unitary item, in other embodiments panels may each be separate pieces which may be, for example, adhered to each other through the use of welding, adhesive, crimping, molding, etc.

In the assembled apparatus (FIG. 1), the standing wall panels (220, 230) of the four coupled corner parts 200 together define an open-top and open-bottom fill receptacle 202. As shown in FIG. 1, one or more of the interior sides of the corner parts may have, referenced as indicia 204, markings, etchings, or ridges on the inside and/or outside that may indicate measurements. For example, a respective marking may indicate 2 oz, 4 oz, 6 oz, and such according to a particular length L and width W configuration of the apparatus. The indicia 204 may otherwise or additionally be used relatively by a practiced or instructed user to produce consistent food production results at any dimensional configuration of the apparatus 100.

The base flaps (210, 240) may further be shaped to match the shape of a particular food item. For example the flaps may extend so as to match the edge of a standard tortilla. It may be understood that in other embodiments the base flaps (210, 240) may be shaped and sized to match any number of different products, for example flatbreads, 6 inch tortillas, 10 inch crepe, etc. The top edges of the corner parts of the apparatus together define an opening through which to pass fill items into the receptacle 202 to allow for the placement of food in the fill receptacle 202.

Referring to FIG. 5, an exemplary embodiment of a tamping device 400 is shown. The illustrated tamping device 400 has a tamping plate 402 for use in tamping down on ingredients placed in the receptacle. The illustrated tamping device 400 has a handle 404, which may be, for example, a circle, oval, sphere, cylinder, etc. The handle 404 is illustrated as connected to the base 402 via a stem 406. In some embodiments one or more sides of the plate 402 may have a sharp edge 408, which can be utilized to cut a food item such as a tortilla, crepe, flatbread, etc. The sharp edge 408 may be formed from the plate 402 or may be an additional piece that is inserted into an indentation in and edge of the plate 402.

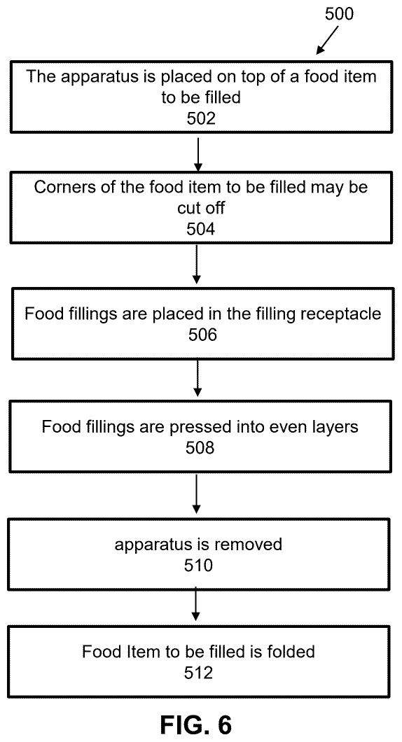

Referring to FIG. 6, an exemplary method 500 for utilizing the apparatus for filling a food item 500 may be shown and described. In a first step 502 the apparatus may be placed on top of a food item to be filled, for example but not limited to, on top of a flatbread, crepe, or tortilla. In a next step 504 edges and/or corners of the food item to be filled may be cut off, for example in making a burrito the corners of a tortilla may be cut off or otherwise removed. It may be understood that the corners of the food item 10 in the spaces 208 (FIG. 1), each between the trailing edge 212 and first edge 241 of a corner part 200, may be the only sections of the food item 10 showing beyond the base flaps (210, 240) of the apparatus 200, and the corners of the food item 10 may be cut by following the effective outer edges of the coupled base flaps (210, 240), which may leave a cross shaped tortilla or other food time that may be easily folded once the apparatus 100 is removed.

In a next step 506 food filling may be placed in the receptacle of the apparatus 100. For example, in an exemplary embodiment of making a burrito, multiple layers of ingredients may be placed one at a time, e.g. rice, beans, protein, etc. In a next step 508, the food fillings placed in step 506 may be pressed into even layers, for example by using the tamping device 400. In a next step the 510, the apparatus may be removed from the food item to be filled. In a final step 512, the food item may be completed, for example in the embodiment of making the burrito, the tortilla may be folded and grilled in order to be sealed.

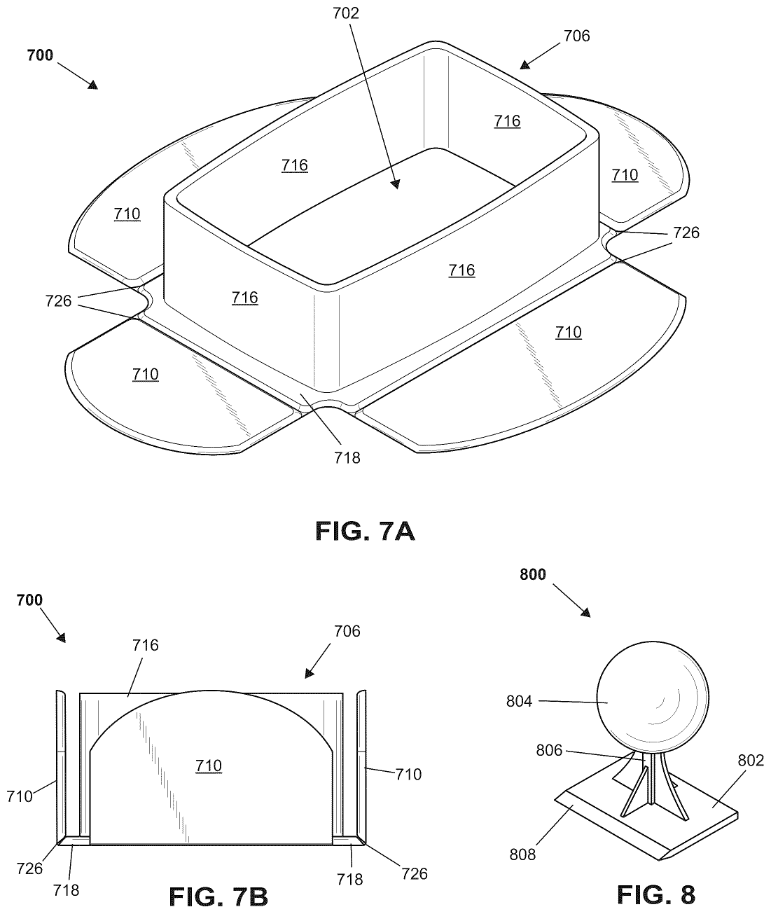

Turning to FIGS. 7-8, another embodiment of an apparatus 700 for filling a food item and a tamping device 800 is disclosed. The embodiment of apparatus 700 may be formed as a unitary structure, and therefore may be produced as a single piece. Apparatus 700 may include an open-top and open-bottom fill receptacle 702 defined by four side walls 716. As shown in the figures, side walls 716 may be oriented substantially vertically when apparatus 700 is positioned on a horizontal surface. Side walls 716 may have a substantially rectangular configuration, and each sidewall may extend substantially linearly between the sidewalls adjacent thereto. In some embodiments, as shown in FIG. 7A, each sidewall 716 may extend slightly arcuately between adjacent sidewalls, thereby imparting a convex shape to receptacle 702. This can allow for a slight bulging of the food item as it is being filled within the receptacle according to the method disclosed herein.

Receptacle 702 may have any desired shape. For example, as in the illustrated embodiment, as viewed from above, receptacle 702 may be substantially rectangular, and may have a slightly convex configuration. However, any other shape for receptacle 702 may be contemplated and provided as desired. For example, as viewed from above, embodiments of receptacle 702 may have a non-convex rectangular shape, a square shape, and so forth.

Extending outwardly from the bottom end of fill receptacle 702 may be a surrounding flange 718. Flange 718 may be disposed around the periphery of receptacle 702 and may be positioned orthogonally to walls 716. In some embodiments, flange 718 may have a four-leaf configuration, with each leaf extending outwardly from each wall 716. Extending further outward from flange 718, for example from each leaf of flange 718, may be a flap 710. In a first configuration, flaps 710 may be disposed in the same plane as flange 718, as shown in FIG. 7A. That is, when apparatus 700 is positioned on a horizontal surface, side walls 716 may be oriented substantially vertically, while flange 718 and flaps 710 may be oriented substantially horizontally. The first configuration of flaps 710 may be used for filling a food item, substantially according to the method disclosed hereinabove. In the first configuration, flange 718 and flaps 710 may form a coextensive, flat lower surface.

Each flap 710 may be connected to flange 718 via a hinge 726, which may be a living hinge. In a second configuration, as shown in FIG. 7B, flaps 710 may be oriented substantially parallel to walls 716 and orthogonal to flange 718. Apparatus 700 may be placed into the second configuration for compactness, ease of storage, or for stacking with other apparatuses 700. Each flap 710 may have a width that is substantially similar to the width of a corresponding side wall 716. In some embodiments, each flap may have a height, when viewed in the second configuration, that is substantially similar to the height of a corresponding side wall 716. Furthermore, in some embodiments, each flap may have an arcuate outer edge; however, any shape for the outer edge may be contemplated and provided as desired.

FIG. 8 shows another exemplary embodiment of a tamping device 800, having a spherical handle 804, a reinforced stem 806, a tamping plate 802 and a sharp edge 808 extending from the tamping plate.

It may be understood that in an exemplary embodiment the apparatus for filling a food item may be shaped and sized to allow for easy placement in the center of a specific food item, e.g. a tortilla. For example, the sizing of the receptacle and panels may allow for about ¾ an inch of tortilla to be exposed beyond the perimeter of the base flaps, which may be understood to allow for successful folding and packaging of the end food product.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An apparatus for filling a food item, comprising:
a filling receptacle enclosed by two pairs of opposed walls and having an open first end and an open second end;
two pairs of opposed flaps disposed proximate the second end of the filling receptacle, each flap extending outwardly from each corresponding wall and oriented orthogonally thereto;
wherein, when the apparatus is placed on a horizontal surface, the walls are disposed in a vertical orientation and the flaps extend horizontally outward from the filling receptacle, and the first end of the filling receptacle is above the second end.

2. The apparatus of claim 1, further comprising a flange disposed proximate the second end of the filling receptacle, the flange being disposed between, and connected to, a wall and a corresponding flap.

3. The apparatus of claim 2, wherein the flange is connected to the corresponding flap via a hinge.

4. The apparatus of claim 3, wherein each flap is movable between a first configuration wherein the flap is orthogonal to a corresponding wall, and a second configuration, wherein the flap is parallel to the corresponding wall.

5. The apparatus of claim 2, wherein the flange and the flaps form a coextensive, flat surface, the surface being disposed on a side facing opposite the vertical extension of the walls.

6. The apparatus of claim 1, further comprising a tamping device, the tamping device having a handle, a tamping plate, and a stem extending between the handle and the tamping plate.

7. The apparatus of claim 6, further comprising a sharp edge provided on the tamping plate.

8. The apparatus of claim 1, further comprising four separable corner parts, wherein:
each wall is formed by cooperating first panels of two adjacent corner parts; and
each flap is formed by cooperating second panels of the two adjacent corner parts.

9. The apparatus of claim 8, wherein each corner part comprises two vertical first panels and two horizontal second panels, each second panel being coupled to one corresponding first panel.

10. The apparatus of claim 9, wherein the two first panels are hingedly coupled to each other.

11. The apparatus of claim 9, wherein each second panel is hingedly coupled to the corresponding first panel.

12. The apparatus of claim 8, wherein the adjacent corner parts are slidably coupled to each other in parallel relation, thereby allowing for adjustment of dimensions of the filling receptacle.

13. A method for filling a food item utilizing the apparatus of claim 1, the method comprising:
providing a flat, foldable food item to be filled;
positioning the apparatus over the food item;
placing ingredients into the filling receptacle;
removing the apparatus; and
folding the flat, foldable food item so as to enclose the ingredients therein.

14. The method of claim 13, wherein the apparatus is positioned such that the filling receptacle and all flaps are disposed over the food item.

15. The method of claim 14, wherein portions of the food item are exposed between corner-adjacent flaps of the apparatus, the method further comprising removing the exposed portions of the food item prior to removing the apparatus.

16. The method of claim 13, further comprising utilizing a tamping device to compress the ingredients in the filling receptacle.

17. The method of claim 13, wherein ingredients are placed into the filling receptacle by layers, the method further comprising utilizing a tamping device to compress each layer prior to placement of a subsequent layer.

18. The method of claim 13, wherein each layer has a single ingredient.
